(19) United States
(12) Patent Application Publication
(10) Pub. No.: US 2014/0164837 A1
(43) Pub. Date: Jun. 12, 2014

(54) MULTI-CORE PROCESSOR, DEVICE HAVING THE SAME, AND METHOD OF OPERATING THE MULTI-CORE PROCESSOR

(71) Applicant: SAMSUNG ELECTRONICS CO., LTD., Suwon-si (KR)

(72) Inventor: Se Hyun YANG, Seoul (KR)

(73) Assignee: SAMSUNG ELECTRONICS CO., LTD., Suwon-si (KR)

(21) Appl. No.: 14/070,595

(22) Filed: Nov. 4, 2013

(30) Foreign Application Priority Data
Dec. 7, 2012 (KR) 10-2012-0141967

(51) Int. Cl. G06F 11/277

(52) U.S. Cl. CPC G06F 11/277
USPC 714/37

(57) ABSTRACT

A multi-core processor includes a plurality of cores, each core configured to output an scan output pattern in response to an input of an scan input pattern, a multiplexing circuit configured to be responsive to a selection signal to output one of the scan output patterns output by the plurality of cores, and a comparison circuit configured to compare the scan output patterns with one another in units of bits, and to generate a plurality of comparison signals corresponding to comparison results.

### CROSS-REFERENCE TO RELATED APPLICATIONS

A claim of priority under 35 U.S.C. §119(a) is made to Korean Patent Application No. 10-2012-0141967, filed on Dec. 7, 2012, the disclosure of which is hereby incorporated by reference in its entirety.

### BACKGROUND

Example embodiments relate to a processor, and more particularly, to a multi-core processor, a device including a multi-core processor, and Design for Test (DFT) techniques to facilitate testing of the multi-core processor.

In general, an electronic component may be designed and fabricated in consideration of the testing that will be utilized to ensure operability of the electronic component. This design/fabrication approach is generally referred to as Design for Test (DFT). Particularly in the case of complex circuit designs, application of DFT techniques can significantly reduce the costs of testing, thereby reducing overall fabrication costs.

For example, processors may be designed to allow for execution of a scan chain procedure in order to test the operation of flip-flops included in the processors. In the scan chain technique, automatic test equipment inputs a scan input pattern to scan input ports of a processor, and tests the reliability of the processor based on a scan output pattern that is output by scan output ports of the processor in response to scan input pattern.

In the meantime, multi-core processors have been developed and fabricated to include a plurality of independent processing cores. As such, as the number of flip-flops contained in the multi-core processor is quite large as compared to a single core processor, the number of scan input ports and scan output ports for testing the multi-core processor has dramatically increased.

### SUMMARY

According to an aspect of the inventive concept, a multi-core processor is provided which includes a plurality of cores, each core configured to output an scan output pattern in response to an input of an scan input pattern, a multiplexing circuit configured to be responsive to a selection signal to output one of the scan output patterns output by the plurality of cores, and a comparison circuit configured to compare the scan output patterns with one another in units of bits, and to generate a plurality of comparison signals corresponding to comparison results.

According to another aspect of the inventive concept, a computing device includes the multi-core processor and peripheral devices which are controlled by the multi-core processor. The multi-core processor includes a plurality of cores, each core configured to output an scan output pattern in response to an input of an scan input pattern, a multiplexing circuit configured to be responsive to a selection signal to output one of the scan output patterns output by the plurality of cores, and a comparison circuit configured to compare the scan output patterns with one another in units of bits, and to generate a plurality of comparison signals corresponding to comparison results.

According to yet another aspect of the inventive concept, a method of operating a multi-core processor comprising a plurality of cores is provided. The method includes receiving a scan input pattern, wherein the receiving is performed in each of the plurality of cores, outputting one of a plurality of scan output patterns output by the plurality of cores, in response to a selection signal, and comparing the scan output patterns with one another in units of bits and generating a plurality of comparison signals corresponding to results of the comparisons.

### BRIEF DESCRIPTION OF THE DRAWINGS

The above and other aspects and features of example embodiments will become apparent from the detailed description that follows with reference to the accompanying drawings. The drawings are intended to depict example embodiments and should not be interpreted to limit the intended scope of the claims. Also, the drawings are not to be considered as drawn to scale unless explicitly noted.

FIG. 1 is a schematic block diagram of a system for testing a multi-core processor, according to an embodiment of the inventive concept.

FIG. 2 is a schematic block diagram of an embodiment of the multi-core processor illustrated in FIG. 1.

FIG. 3 is a schematic block diagram of another embodiment of the multi-core processor illustrated in FIG. 1.

FIG. 4 is a schematic block diagram of still another embodiment of the multi-core processor illustrated in FIG. 1.

FIG. 5 is a schematic block diagram of still another embodiment of the multi-core processor illustrated in FIG. 1.

FIG. 6 is a flowchart for reference in describing a method of testing the multi-core processor illustrated in FIG. 1 according to an embodiment of the inventive concept; and

FIG. 7 is a schematic block diagram illustrating an example of a data processing device including the multi-core processor illustrated in FIG. 1.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

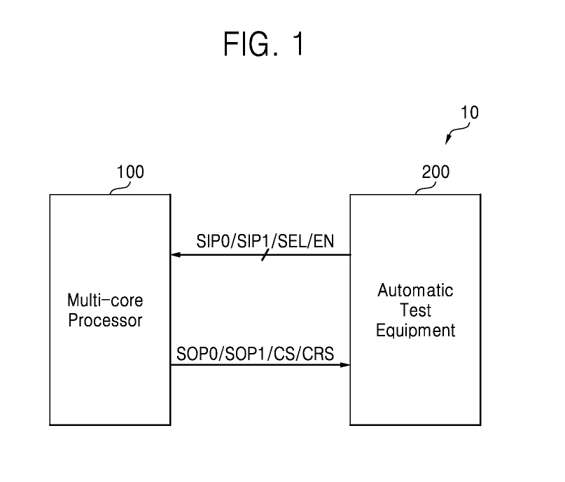

FIG. 1 is a schematic block diagram of a system 10 for testing a multi-core processor 100, according to an embodiment of the inventive concept. Referring to FIG. 1, the system 10 may include the multi-core processor 100 and automatic test equipment (ATE) 200.

The automatic test equipment 200 may transmit scan input patterns SIP0 and SIP1 to the multi-core processor 100, and receive scan output patterns SOP0 and SOP1 from the multi-core processor 100.

The automatic test equipment 200 may determine whether the multi-core processor 100 is operating normally based on the scan output patterns SOP0 and SOP1 received from the multi-core processor 100. For example, the automatic test equipment 200 may compare the scan output patterns SOP0 and SOP1 received from the multi-core processor 100 with predetermined result patterns.

When the scan output patterns SOP0 and SOP1 matches the predetermined result patterns, the automatic test equipment 200 may determine that the multi-core processor 100 is operating normally. On the other hand, when the scan output patterns SOP0 and SOP1 is not the same with the predetermined result patterns, the automatic test equipment 200 may determine that the multi-core processor 100 is operating abnormally.

According to an embodiment, the automatic test equipment 200 may also transmit a selection signal SEL to the multi-core processor 100. In response to the selection signal SEL, the multi-core processor 100 may output, as a scan output pattern, one of plural scan output patterns of respective cores of the multi-core processor 100.

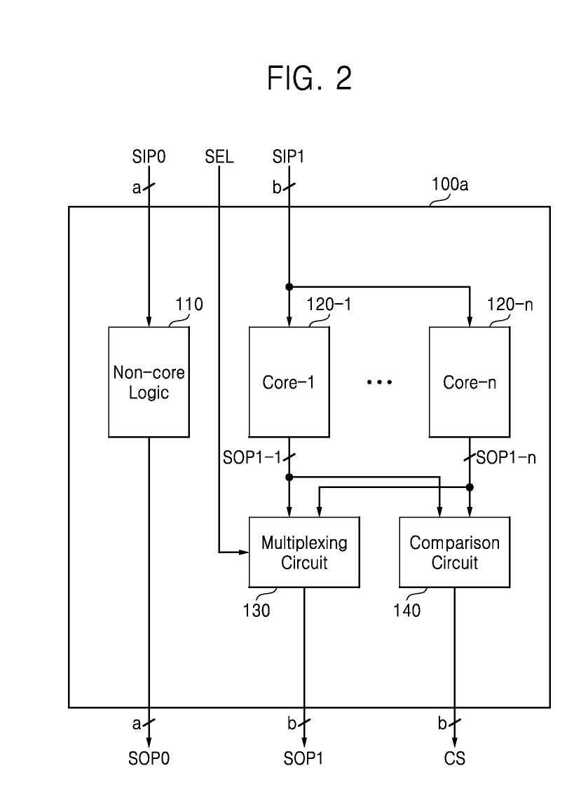

As will explained below with reference to the examples of FIGS. 2 through 5, the multi-core processor 100 may be responsive to the selection signal SEL to output, as the scan output pattern SOP1, one of plural scan output patterns SOP1-1 through SOP1-n (where n denotes a natural number) which are respectively output by a plurality of cores 120-1 through 120-n included in the multi-core processor 100, to the automatic test equipment 200.

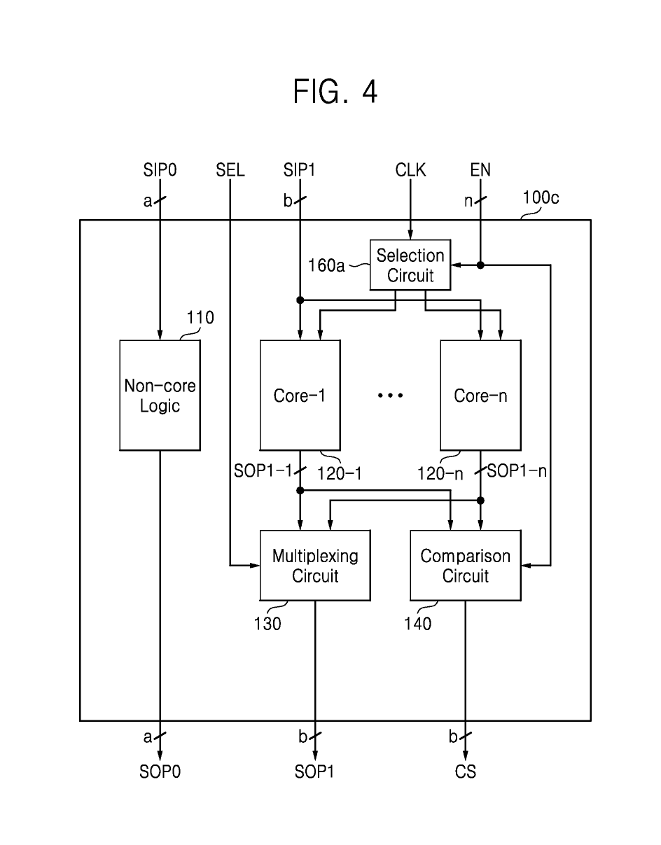

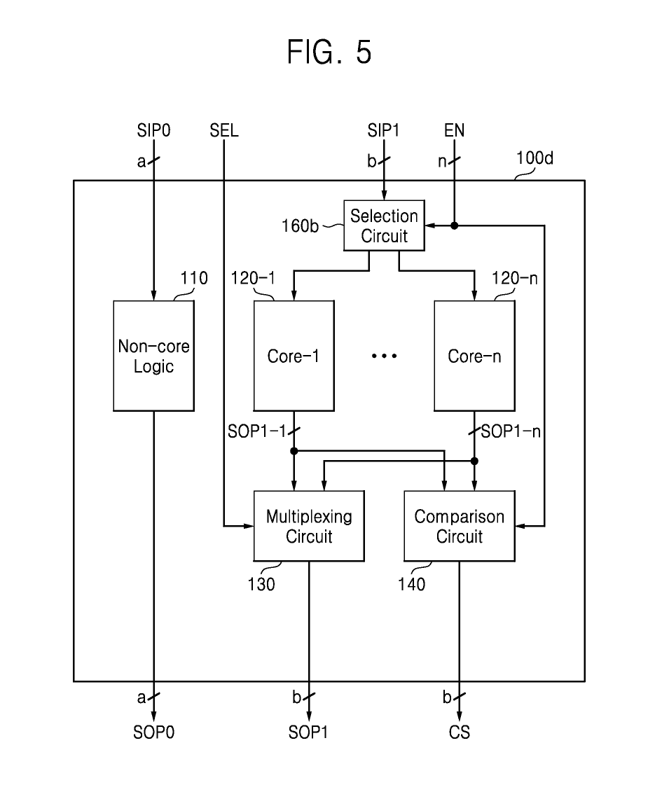

As will explained below with reference to the examples of FIGS. 4 and 5, the automatic test equipment 200 may also transmit an enable signal EN to the multi-core processor 100. In this case, the multi-core processor 100 may be responsive to the enable signal EN so as to control the cores 120-1 through 120-n of the multi-core processor 100 so that less than all of the cores 120-1 through 120-n operate at the same time.

Example embodiments of the inventive concept will now be described with reference to FIGS. 2 through 5.

FIG. 2 is a schematic block diagram of a multi-core processor 100a, which is an embodiment of the multi-core processor 100 of FIG. 1. Referring to FIGS. 1 and 2, the multi-core processor 100a may include a non-core logic 110, a plurality of cores 120-1 through 120-n, a multiplexing circuit 130, and a comparison circuit 140.

The non-core logic 110 may transmit the scan output pattern SOP0 to the automatic test equipment 200 in response to the scan input pattern SIP0 received from the automatic test equipment 200. The non-core logic 110 may be a logic circuit or circuits of the multi-core processor 100 other than those logic circuits which constitute the cores 120-1 through 120-n, the multiplexing circuit 130, and the comparison circuit 140 of the multi-core processor 100a. For example, the non-core logic 110 may include a L3 cache and/or a memory controller.

The cores 120-1 through 120-n may respectively output the scan output patterns SOP1-1 through SOP1-n in response to the scan input pattern SIP1 received from the automatic test equipment 200. For example, the first core 120-1 from among the cores 120-1 through 120-n may output the scan output pattern SOP1-1 in response to the scan input pattern SIP1, and the n-th core 120-n from among the cores 120-1 through 120-n may output the scan output pattern SOP1-n in response to the scan input pattern SIP1.

Each of the cores 120-1 through 120-n may include, for example, an arithmetic logic unit (ALU), a floating point unit (FPU), a level-1 (L1) cache, and/or a level-2 (L2) cache. The structure and functionality of the cores 120-1 through 120-n may be the same as each other or different from each other. Further, the cores 120-1 through 120-n may have the same scan chains.

The multiplexing circuit 130 may output, as the scan output pattern SOP1 to the automatic test equipment 200, one of the scan output patterns SOP1-1 through SOP1-n respectively output by the cores 120-1 through 120-n, in response to the selection signal SEL output by the automatic test equipment 200. The configuration of the multiplexing circuit 130 is not limited and may include a plurality of multiplexers (not shown).

The comparison circuit 140 may compare the scan output patterns SOP1-1 through SOP1-n respectively output by the cores 120-1 through 120-n with one another in units of bits and may output a plurality of comparison signals CS corresponding to results of the comparisons to the automatic test equipment 200.

Each of the comparison signals CS may represent whether the scan output patterns SOP1-1 through SOP1-n are identical with each other in units of bits. For example, when respective first bits of the scan output patterns SOP1-1 through SOP1-n are all identical, a first comparison signal from among the comparison signals CS may be logic low.

On the other hand, when the respective first bits of the scan output patterns SOP1-1 through SOP1-n are different from one another, the first comparison signal from among the comparison signals CS may be logic high.

Assuming that the selection signal is applied to one scan input port, the scan input pattern SOP0 is an ‘a’-bit pattern (where ‘a’ denotes a natural number) and the scan input pattern SOP1 is a ‘b’-bit pattern (where ‘b’ denotes a natural number). In this case, the multi-core processor 100a requires (a+b+1) scan input ports and (a+2*b) scan output ports. In contrast, a conventional multi-core processor would require (a+n*b) scan input ports and (a+n*b) scan output ports. Thus, the inclusion of the multiplexing circuit 130 and the comparison circuit 140 in the multi-core processor 100a of FIG. 2 may allow for a reduced number of scan input ports and scan output ports.

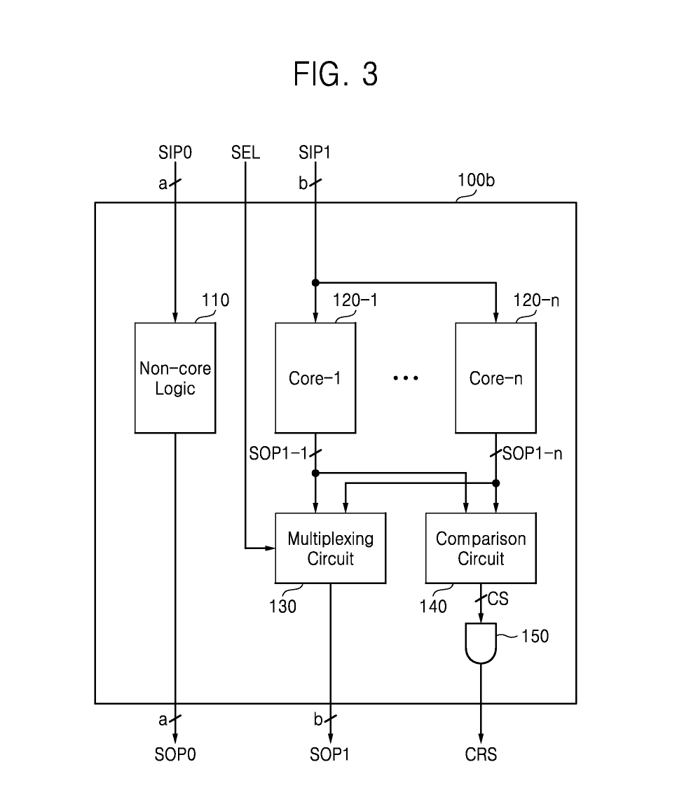

FIG. 3 is a schematic block diagram of a multi-core processor 100b, which is another embodiment of the multi-core processor 100 of FIG. 1. Referring to FIGS. 1 and 3, the multi-core processor 100b may include the non-core logic 110, the cores 120-1 through 120-n, the multiplexing circuit 130, the comparison circuit 140, and a Boolean logic gate 150.

The structure and functionality of the multi-core processor 100b of FIG. 3 are substantially the same as those of the multi-core processor 100a of FIG. 1, except for the addition of the Boolean logic gate 150. The Boolean logic gate 150 may perform a logic operation with respect to the comparison signals CS output by the comparison circuit 140 and may output a comparison result signal CRS corresponding to a result of the logic operation.

Since each of the comparison signals CS represents whether the scan output patterns SOP1-1 through SOP1-n are identical with each other in units of bits, the comparison result signal CRS may indicate whether the scan output patterns SOP1-1 through SOP1-n are identical with one another.

According to an embodiment, the logic operation of the Boolean logic gate 150 may be an AND operation, an OR operation, a NAND operation, a NOR operation, an exclusive-OR (XOR) operation, or an exclusive-NOR (XNOR) operation. For example, the Boolean logic gate 150 may be an AND gate, an OR gate, a NAND gate, a NOR gate, an XOR gate, or an XNOR gate.

Again assuming that the scan input pattern SOP0 is an a-bit pattern (where a denotes a natural number) and the scan input pattern SOP1 is a b-bit pattern (where b denotes a natural number), the multi-core processor 100b needs (a+b+1) scan input ports and (a+b+1) scan output ports. Thus, the inclusion of the multiplexing circuit 130, the comparison circuit 140, and the Boolean logic gate 150 in the multi-core processor 100b may reduce the required number of scan input ports and scan output ports.

FIG. 4 is a schematic block diagram of a multi-core processor 100c, which is still another embodiment of the multi-core processor 100 of FIG. 1. Referring to FIGS. 1 and 4, the multi-core processor 100c may include the non-core logic 110, the cores 120-1 through 120-n, the multiplexing circuit 130, the comparison circuit 140, and a selection circuit 160a.

The structure and functionality of the multi-core processor 100c of FIG. 4 are substantially the same as those of the multi-core processor 100a of FIG. 2, except for the addition of selection circuit 160a.

In the example of this embodiment, the selection circuit 160a may output a clock signal CLK to at least two but less than all of the cores 120-1 through 120-n, in response to the enable signal EN. For example, the selection circuit 160a may be implemented by a demultiplexer.

The clock signal CLK may be output by the automatic test equipment 200, or may be provided from some other source.

In this embodiment, some (i.e., two more) of the cores 120-1 through 120-n output scan output patterns in response to the clock signal CLK, and others of the cores 120-1 through 120-n output no scan output patterns. As such, power consumption of the multi-core processor 100c may be reduced.

Here, the comparison circuit 140 may be responsive to the enable signal EN to compare the scan output patterns output by the at least two cores with one another in units of bits and may output a plurality of comparison signals CS corresponding to results of the comparisons to the automatic test equipment 200.

FIG. 5 is a schematic block diagram of a multi-core processor 100d, which is still another embodiment of the multi-core processor 100 of FIG. 1. Referring to FIGS. 1 and 5, the multi-core processor 100d may include the non-core logic 110, the cores 120-1 through 120-n, the multiplexing circuit 130, the comparison circuit 140, and a selection circuit 160b.

The structure and functionality of the multi-core processor 100d of FIG. 5 are substantially the same as those of the multi-core processor 100a of FIG. 2, except for the addition of the selection circuit 160b.

The selection circuit 160b may output the scan input pattern SIP1 to at least two but less than all of the cores 120-1 through 120-n, in response to the enable signal EN. For example, the selection circuit 160b may be implemented by a demultiplexer.

In this case, the comparison circuit 140 may be responsive to the enable signal EN to compare the scan output patterns output by the at least two cores with one another in bit units and may output a plurality of comparison signals CS corresponding to results of the comparisons to the automatic test equipment 200.

In this embodiment, some (i.e., two more) of the cores 120-1 through 120-n output scan output patterns in response to the scan input patter SIP1, and others of the cores 120-1 through 120-n output no scan output patterns. As such, power consumption of the multi-core processor 100d may be reduced.

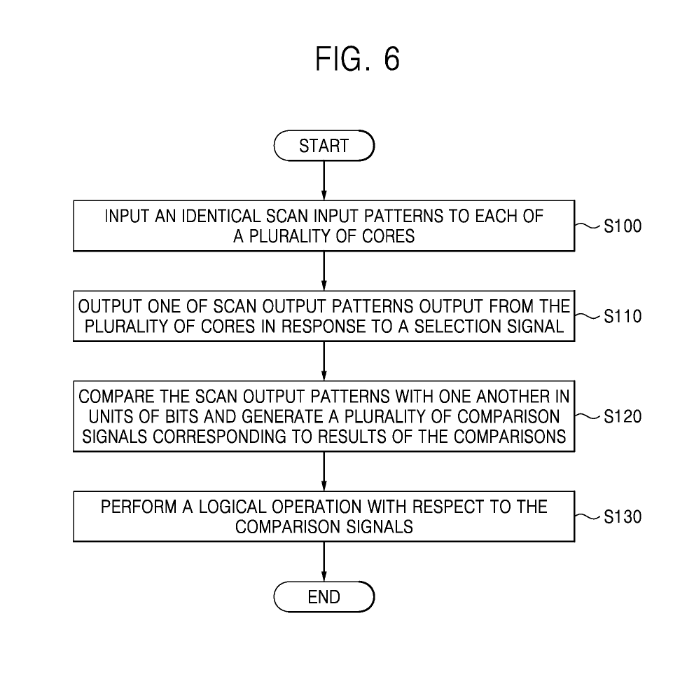

FIG. 6 is a flowchart for reference in describing a method of testing the multi-core processor 100 of FIG. 1. The method represented by FIG. 6 is primarily directed to the multi-core processor 100b of the embodiment of FIG. 3. However, variations in the method to accommodate the configurations of the multi-core processors 100a, 100c and 100d of the embodiments of FIGS. 2, 4 and 5 will be readily to those skilled in the art.

Referring to FIGS. 1, 3 and 6, the automatic test equipment 200 may transmit the scan input patterns SIP0 and SIP1 to the multi-core processor 100b, and in operation S100, the scan input pattern SIP1 may be input to each of the cores 120-1 through 120-n included in the multi-core processor 100b. The cores 120-1 through 120-n may output the scan output patterns SOP1-1 through SOP1-n, respectively, in response to the scan input pattern SIP1.

In operation S110, the multiplexing circuit 130 may output, as the scan output pattern SOP1, one of the scan output patterns SOP1-1 through SOP1-n respectively output by the cores 120-1 through 120-n to the automatic test equipment 200, in response to the selection signal SEL output by the automatic test equipment 200.

In operation S 120, the comparison circuit 140 may compare the scan output patterns SOP1-1 through SOP1-n respectively output by the cores 120-1 through 120-n with one another in units of bits to generate a plurality of comparison signals CS corresponding to results of the comparisons.

In operation S130, the Boolean logic gate 150 may perform a logic operation with respect to the comparison signals CS output by the comparison circuit 140, and may output a comparison result signal CRS corresponding to a result of the logic operation.

As demonstrated above, a multi-core processor and related method according to the embodiments of the inventive concept allow for a reduction in the number of scan input ports and scan output ports necessary for testing. This allows for a reduction in Design for Test (DFT) overhead costs.

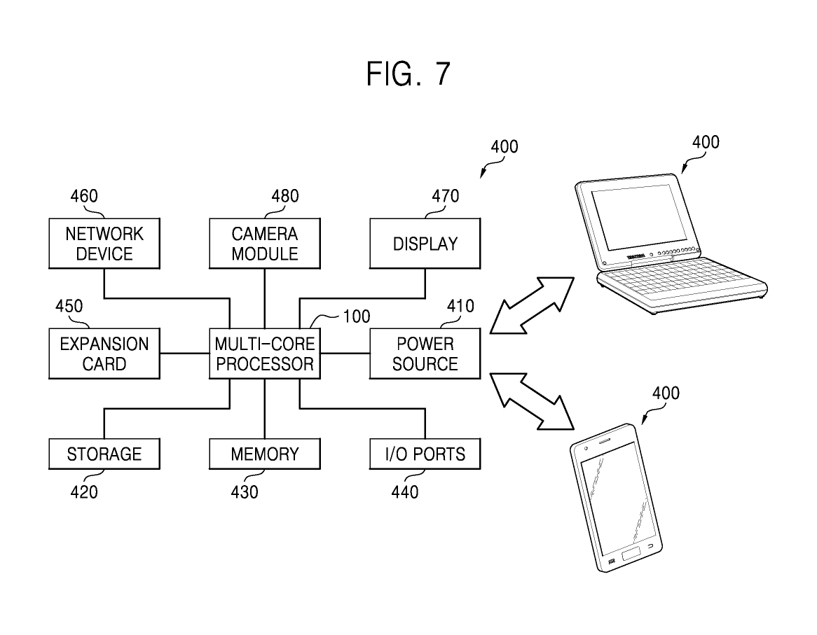

FIG. 7 is a schematic block diagram of a computing device 400 including the multi-core processor 100 of FIG. 1. The computing device 400 may be any of a number of different types of devices, such as a personal computer (PC) or a data server.

The computing device 400 may also be a portable electronic device. As examples, the portable electronic device may be implemented by using a mobile phone, a smart phone, a tablet PC, a personal digital assistant (PDA), an enterprise digital assistant (EDA), a digital still camera, a digital video camera, a portable multimedia player (PMP), a personal (or portable) navigation device (PND), a handheld game console, a mobile internet device (MID), or an e-book.

The computing device 400 may include the multi-core processor 100 of FIG. 1 and peripheral devices. The peripheral devices may be a power source 410, a storage 420, a memory 430, input/output (I/O) ports 440, an expansion card 450, a network device 460, and a display 470. According to an embodiment, the computing device 400 may further include a camera module 480.

The multi-core processor 100 may control the operation of at least one of the elements 410 through 480. The power source 410 may supply an operational voltage to at least one of the elements 100 and 420-480. The storage 420 may, for example, be implemented by using a hard disk drive or a solid state drive (SSD).

The memory 430 may be implemented by using a volatile memory and/or a non-volatile memory. According to an embodiment, a memory controller capable of controlling a data access operation, for example, a read operation, a write operation (or a program operation), or an erase operation, with respect to the memory 430 may be integrated into or embedded in the multi-core processor 100. According to another embodiment, the main controller may be installed between the multi-core processor 100 and the memory 430. The memory 430 may be implemented by using a removable memory. The memory 430 may be a universal flash storage (UFS).

The I/O ports 440 denote ports capable of transmitting data to the computing device 400 or data output from the computing device 400 to an external device. For example, the I/O ports 440 may be a port for connecting a pointing device, such as a computer mouse, a touch pad, or a pen, to the computing device 400, a port for connecting a printer to the computing device 400, and a port for connecting a universal serial bus (USB) drive to the computing device 400.

The expansion card 450 may be implemented by using a secure digital (SD) card, a multimedia card (MMC), or an embedded MMC (eMMC). In some cases, the expansion card 450 may be a subscriber identification module (SIM) card or a universal subscriber identity module (USIM) card.

The network device 460 denotes a device capable of connecting the computing device 400 to a wired or wireless network.

The display 470 may display data output from the storage device 420, the memory 430, the I/O ports 440, the expansion card 450, or the network device 460. The display 470 may be implemented by using a thin film display (e.g., a liquid crystal display (LCD)), a light emitting diode (LED) display, an organic LED (OLED) display, an active matrix OLED (AMOLED) display, or a flexible display.

The camera module 480 denotes a module capable of converting an optical image into an electrical image. Accordingly, an electrical image output from the camera module 480 may be stored in the storage 420, the memory 430, or the expansion card 450. The electrical image output from the camera module 480 may be displayed on the display 470.

While the inventive concept has been particularly shown and described with reference to exemplary embodiments thereof, it will be understood that various changes in form and details may be made therein without departing from the spirit and scope of the following claims.

What is claimed is:

1. A multi-core processor comprising:
a plurality of cores, each core configured to output an scan output pattern in response to an input of an scan input pattern;
a multiplexing circuit is configured to be responsive to a selection signal to output one of the scan output patterns output by the plurality of cores; and
a comparison circuit which is configured to compare the scan output patterns with one another in units of bits, and to generate a plurality of comparison signals corresponding to comparison results.

2. The multi-core process of claim 1, further comprising b scan input terminals to which the scan input pattern is applied, where b is a plural natural number, wherein the b scan input terminals are commonly connected to inputs of the plurality of cores.

3. The multi-core processor of claim 2, further comprising 2*b scan output terminals, wherein b of the scan output terminals are connected to an output of the multiplexing circuit from which the one of the scan output patterns is output, and b others of the scan output terminals are connected to an output of the comparison circuit from which the plurality of comparison signals are output.

4. The multi-core processor of claim 1, further comprising a Boolean logic gate which performs a logic operation with respect to the plurality of comparison signals to generate and output a comparison result signal.

5. The multi-core processor of claim 4, wherein the Boolean logic gate is an AND gate, an OR gate, a NAND gate, a NOR gate, an exclusive-OR (XOR) gate, or an exclusive-NOR (XNOR) gate.

6. The multi-core processor of claim 4, further comprising:
b scan input terminals to which the scan input pattern is applied, where b is a plural natural number, wherein the b scan input terminals are commonly connected to inputs of the plurality of cores; and
b+1 scan output terminals, wherein b of the scan output terminals are connected to an output of multiplexing circuit from which the one of the scan output patterns is output, and one other of the scan output terminals is connected to an output of the Boolean logic gate from which the comparison result signal is output.

7. The multi-core processor of claim 1, further comprising a selection circuit which outputs a clock signal to at least two but not all of the plurality of cores in response to an enable signal, wherein only the cores which receive the clock signal from the selection circuit output the scan output pattern in response to the input of the scan input pattern.

8. The multi-core process of claim 7, further comprising b scan input terminals to which the scan input pattern is applied, where b is a plural natural number, wherein the b scan input terminals are commonly connected to inputs of the plurality of cores.

9. The multi-core processor of claim 1, further comprising a selection circuit which transmits the scan input pattern to at least two but not all of the plurality of cores in response to an enable signal, wherein only those cores which receive the scan input signal from the selection circuit output the scan output pattern.

10. The multi-core process of claim 9, further comprising b scan input terminals to which the scan input pattern is applied, where b is a plural natural number, wherein the b scan input terminals are connected to an input of the selection circuit.

11. A computing device comprising:
the multi-core processor of claim 1; and
peripheral devices which are controlled by the multi-core processor.

12. The computing device of claim 11, further comprising a Boolean logic gate which performs a logic operation with respect to the plurality of comparison signals to generate and output a comparison result signal.

13. The computing device of claim 11, further comprising a selection circuit which outputs a clock signal to at least two but not all of the plurality of cores in response to an enable signal, wherein only those cores which receive the clock signal from the selection circuit output the scan output pattern in response to the input of the scan input pattern.

14. The computing device of claim 11, further comprising a selection circuit which transmits the scan input pattern to at least two but not all of the plurality of cores in response to an enable signal, wherein only those cores which receive the scan input signal from the selection circuit output the scan output pattern.

15. A method of operating a multi-core processor comprising a plurality of cores, the method comprising:
receiving a scan input pattern, wherein the receiving is performed in each of the plurality of cores;
outputting one of a plurality of scan output patterns output by the plurality of cores, in response to a selection signal; and
comparing the scan output patterns with one another in units of bits and generating a plurality of comparison signals corresponding to results of the comparisons.

16. The method of claim 15, further comprising performing a logic operation with respect to the plurality of comparison signals to generate and output a comparison result signal.

17. The method of claim 15, wherein the receiving comprises outputting a clock signal to at least two but not all of the plurality of cores in response to an enable signal.

18. The method of claim 15, wherein the receiving comprises transmitting the scan input pattern to at least two but not all of the plurality of cores in response to an enable signal.

19. The method of claim 15, wherein the selection signal and the scan input pattern are received from automatic test equipment, and the scan output patterns and the comparison signals are output to the automatic test equipment.
